(19) United States
(12) Patent Application Publication
(10) Pub. No.: US 2013/0124714 A1
(43) Pub. Date: May 16, 2013

(54) VISUALIZATION OF COMBINED PERFORMANCE METRICS

(71) Applicant: Martin BEDNAR, Palo Alto, CA (US)

(72) Inventor: Martin BEDNAR, Palo Alto, CA (US)

(73) Assignee: VMWARE, INC., Palo Alto, CA (US)

(21) Appl. No.: 13/294,756

(22) Filed: Nov. 11, 2011

(51) Int. Cl. G06F 15/173

(52) U.S. Cl. 709/224

(57) ABSTRACT

Embodiments provide a visualization of combined performance metrics representing the operation of a plurality of computing devices. Sets of host performance metrics corresponding to a plurality of host computing devices are combined to create combined performance metrics, each of which is associated with a performance metric type. The combined performance metrics are plotted in a chart that includes a plurality of axes, each associated with a performance metric type. In addition, a baseline value may be plotted on one or more of the axes. A portion, or the entirety, of the chart may be graphically distinguished when a combined performance metric violates a threshold value.

### BACKGROUND

Computing devices, such as servers, personal computers, and mobile telecommunications devices, execute software applications to perform specific functions. The operation of a computing device and/or a software application may be expressed as performance metrics, such as computing resource utilization and/or latency. Performance metrics may be presented to an operator of the computing device as numeric values within a table and/or as one or more bar charts, for example.

Further, an operator may be presented performance metrics corresponding to a group, or “cluster,” of computing devices that execute one or more software applications, such as virtual machines (VMs), distributed computing applications, or application servers. Especially where multiple performance metrics are monitored, such presentations may occupy a relatively large area within a user interface. In addition, visually parsing and comparing such presentations may require significant interpretive effort by the operator. These issues may be exacerbated when performance metrics corresponding to a cluster of computing devices are presented.

### SUMMARY

One or more embodiments described herein provide a visualization (e.g., a chart) of combined performance metrics representing the operation of a plurality of computing devices. Sets of host performance metrics corresponding to a plurality of host computing devices are combined to create combined performance metrics. Each host performance metric may be associated with a performance metric type, such as utilization of and/or latency associated with a computing resource. The sets of host performance metrics may be combined, for example, by including the host performance metrics from each set in the set of combined performance metrics and/or by creating, for each performance metric type, an aggregate performance metric based on the host performance metrics associated with that performance metric type.

In exemplary embodiments, a performance chart that includes an axis associated with each performance metric type is created, and the combined performance metrics are plotted by performance metric type. In addition, a baseline value representing a target value and/or a previous value, for example, may be plotted on one or more of the axes. A portion, or the entirety, of the chart may be graphically distinguished when a combined performance metric violates a threshold value.

This summary introduces a selection of concepts that are described in more detail below. This summary is not intended to identify essential features, nor to limit in any way the scope of the claimed subject matter.

### BRIEF DESCRIPTION OF THE DRAWINGS

FIG. 1 is a block diagram of an exemplary computing device.

FIG. 2 is a block diagram of virtual machines that are instantiated on a computing device, such as the computing device shown in FIG. 1.

FIG. 3 is a block diagram of an exemplary cluster system including computing devices and virtual machines.

FIG. 4 is a flowchart of an exemplary method performed by a monitoring device, such as the monitoring device shown in FIG. 3.

FIG. 5 is an exemplary performance chart that may be created by the monitoring device shown in FIG. 3.

FIG. 6 is an exemplary user interface including a first performance chart representing operation of a first cluster system and a second performance chart representing operation of a second cluster system.

FIG. 7 is an exemplary user interface including a first host performance chart and a second host performance chart.

FIG. 8 is an exemplary combined performance chart that may be created by combining the host performance charts shown in FIG. 7.

### DETAILED DESCRIPTION

Embodiments described herein provide “radar” type performance charts in which each axis is associated with, or mapped to, a performance metric type, such as utilization of and/or latency associated with a computing resource, such as a processor, memory, network, and/or storage (e.g., datastore and/or disk). Observed performance metrics may be combined (e.g., aggregated) and plotted on a corresponding axis, providing a concise, quickly interpreted visual representation of the operation of a computer system. Further, a chart may include a line connecting the plotted performance metrics, and graphical distinction (e.g., color) may be applied to indicate the magnitude of performance metrics relative to predetermined threshold values. Accordingly, a user may quickly assess the state of the system by the shape and/or the color of the line and compare this state to the previous state of the same system and/or to the state of another system.

Further, the operation of a group (e.g., cluster) of hosts may be summarized in the form of aggregate performance metrics, which reduces the amount of information the user is required to interpret. However, when desired, the user may “drill down” to more detail by requesting host performance metrics that correspond to aggregate performance metrics represented by the chart. Similarly, the user may advance from host performance metrics to software application (e.g., virtual machine) performance metrics that correspond to the host performance metrics.

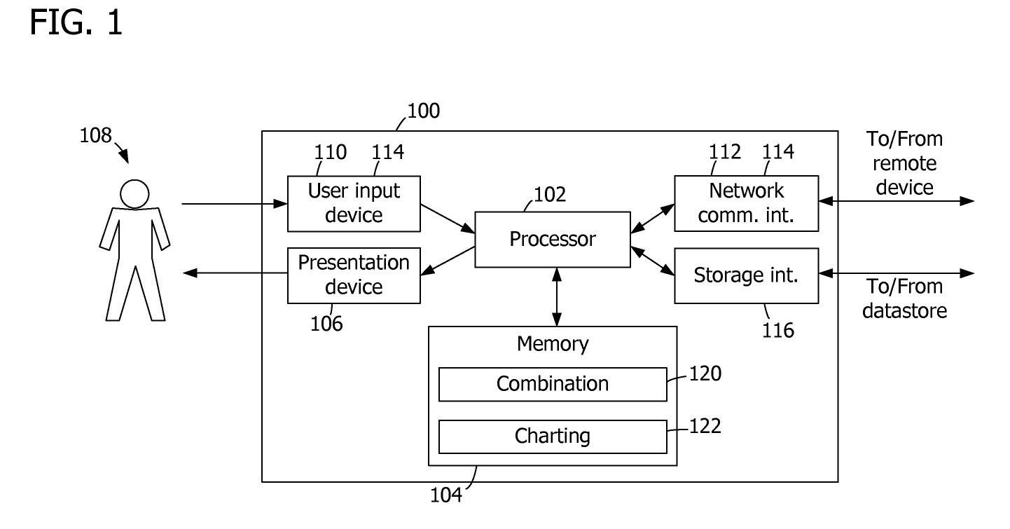

FIG. 1 is a block diagram of an exemplary computing device 100. Computing device 100 includes a processor 102 for executing instructions. In some embodiments, executable instructions are stored in a memory 104. Memory 104 is any device allowing information, such as executable instructions, application performance metrics, host performance metrics, elasticity rules, elasticity actions, configuration options (e.g., threshold values, baseline values), and/or other data, to be stored and retrieved. For example, memory 104 may include one or more random access memory (RAM) modules, flash memory modules, hard disks, solid state disks, and/or optical disks.

Computing device 100 also includes at least one presentation device 106 for presenting information to a user 108. Presentation device 106 is any component capable of conveying information to user 108. Presentation device 106 may include, without limitation, a display device (e.g., a liquid crystal display (LCD), organic light emitting diode (OLED) display, or “electronic ink” display) and/or an audio output device (e.g., a speaker or headphones). In some embodiments, presentation device 106 includes an output adapter, such as a video adapter and/or an audio adapter. An output adapter is operatively coupled to processor 102 and configured to be operatively coupled to an output device, such as a display device or an audio output device.

The computing device 100 may include a user input device 110 for receiving input from user 108. User input device 110 may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of presentation device 106 and user input device 110.

Computing device 100 also includes a network communication interface 112, which enables computing device 100 to communicate with a remote device (e.g., another computing device 100) via a communication medium, such as a wired or wireless packet network. For example, computing device 100 may transmit and/or receive data via network communication interface 112. User input device 110 and/or network communication interface 112 may be referred to as an input interface 114 and may be configured to receive information, such as configuration options (e.g., threshold values), from a user.

Computing device 100 further includes a storage interface 116 that enables computing device 100 to communicate with one or more datastores. In exemplary embodiments, storage interface 116 couples computing device 100 to a storage area network (SAN) (e.g., a Fibre Channel network) and/or to a network-attached storage (NAS) system (e.g., via a packet network). The storage interface 116 may be integrated with network communication interface 112.

In exemplary embodiments, memory 104 stores computer-executable instructions for performing one or more of the operations described herein. Memory 104 may include one or more computer-readable storage media that have computer-executable components embodied thereon. In the example of FIG. 1, memory 104 includes a combination component 120 and a charting component 122.

When executed by processor 102, combination component 120 causes processor 102 to combine a plurality of sets of host performance metrics to create combined performance metrics. Each set of host performance metrics corresponds to a host computing device, and each host performance metric is associated with a performance metric type of a plurality of performance metric types. When executed by processor 102, charting component 122 causes processor 102 to create a chart including a plurality of axes, wherein each axis of the plurality of axes is associated a performance metric type of the plurality of performance metric types, and to plot each combined performance metric of the combined performance metrics on the axis that is associated with the performance metric type associated with the combined performance metric. Charting component 122 may also cause processor 102 to plot a baseline value on one or more axes of the chart. Any portion of the illustrated components may be included in memory 104 based on the function of computing device 100.

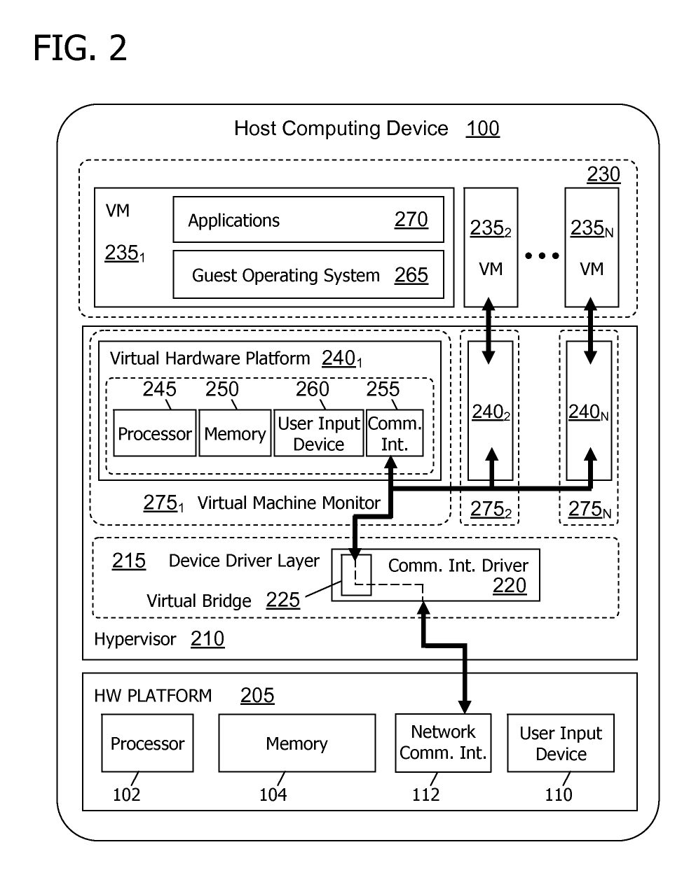

FIG. 2 depicts a block diagram of virtual machines 235₁, 235₂ . . . 235_{N} that are instantiated on a computing device 100, which may be referred to as a host computing device or simply a host. Computing device 100 includes a hardware platform 205, such as an x86 architecture platform. Hardware platform 205 may include processor 102, memory 104, network communication interface 112, user input device 110, and other input/output (I/O) devices, such as a presentation device 106 (shown in FIG. 1). A virtualization software layer, also referred to hereinafter as a hypervisor 210, is installed on top of hardware platform 205.

The virtualization software layer supports a virtual machine execution space 230 within which multiple virtual machines (VMs 235₁-235_{N}) may be concurrently instantiated and executed. Hypervisor 210 includes a device driver layer 215, and maps physical resources of hardware platform 205 (e.g., processor 102, memory 104, network communication interface 112, and/or user input device 110) to “virtual” resources of each of VMs 235₁-235_{N} such that each of VMs 235₁-235_{N} has its own virtual hardware platform (e.g., a corresponding one of virtual hardware platforms 240₁-240_{N}), each virtual hardware platform having its own emulated hardware (such as a processor 245, a memory 250, a network communication interface 255, a user input device 260 and other emulated I/0 devices in VM 235₁).

In some embodiments, memory 250 in first virtual hardware platform 240₁ includes a virtual disk that is associated with or “mapped to” one or more virtual disk images stored in memory 104 (e.g., a hard disk or solid state disk) of computing device 100. The virtual disk image represents a file system (e.g., a hierarchy of directories and files) used by first virtual machine 235₁ in a single file or in a plurality of files, each of which includes a portion of the file system. In addition, or alternatively, virtual disk images may be stored in memory 104 of one or more remote computing devices 100, such as in a storage area network (SAN) configuration. In such embodiments, any quantity of virtual disk images may be stored by the remote computing devices 100.

Device driver layer 215 includes, for example, a communication interface driver 220 that interacts with network communication interface 112 to receive and transmit data from, for example, a local area network (LAN) connected to computing device 100. Communication interface driver 220 also includes a virtual bridge 225 that simulates the broadcasting of data packets in a physical network received from one communication interface (e.g., network communication interface 112) to other communication interfaces (e.g., the virtual communication interfaces of VMs 235₁-235_{N}). Each virtual communication interface for each VM 235₁-235_{N}, such as network communication interface 255 for first VM 235₁, may be assigned a unique virtual Media Access Control (MAC) address that enables virtual bridge 225 to simulate the forwarding of incoming data packets from network communication interface 112. In an embodiment, network communication interface 112 is an Ethernet adapter that is configured in “promiscuous mode” such that all Ethernet packets that it receives (rather than just Ethernet packets addressed to its own physical MAC address) are passed to virtual bridge 225, which, in turn, is able to further forward the Ethernet packets to VMs 235₁-235_{N}. This configuration enables an Ethernet packet that has a virtual MAC address as its destination address to properly reach the VM in computing device 100 with a virtual communication interface that corresponds to such virtual MAC address.

Virtual hardware platform 240₁ may function as an equivalent of a standard x86 hardware architecture such that any x86-compatible desktop operating system (e.g., Microsoft WINDOWS brand operating system, LINUX brand operating system, SOLARIS brand operating system, NETWARE, or FREEBSD) may be installed as guest operating system (OS) 265 in order to execute applications 270 for an instantiated VM, such as first VM 235₁. Virtual hardware platforms 240₁-240_{N} may be considered to be part of virtual machine monitors (VMM) 275₁-275_{N} which implement virtual system support to coordinate operations between hypervisor 210 and corresponding VMs 235₁-235_{N}. Those with ordinary skill in the art will recognize that the various terms, layers, and categorizations used to describe the virtualization components in FIG. 2 may be referred to differently without departing from their functionality or the spirit or scope of the disclosure. For example, virtual hardware platforms 240₁-240_{N} may also be considered to be separate from VMMs 275₁-275_{N}, and VMMs 275₁-275_{N} may be considered to be separate from hypervisor 210. One example of hypervisor 210 that may be used in an embodiment of the disclosure is included as a component in VMware's ESX brand software, which is commercially available from VMware, Inc.

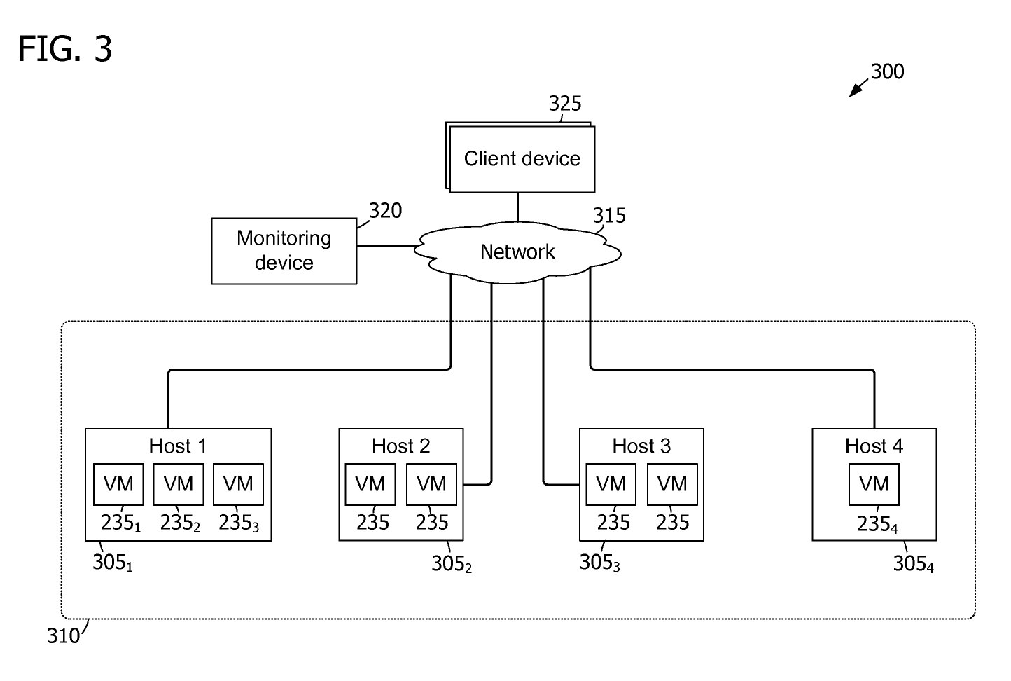

FIG. 3 is a block diagram of an exemplary cluster system 300 of hosts 305 and virtual machines (VMs) 235. Cluster system 300 includes a fault domain 310 with a first host 305₁, a second host 305₂, a third host 305₃, and a fourth host 305₄. Each host 305 executes one or more software application instances. For example, first host 305₁ executes first VM 235₁, second VM 235₂, and third VM 235₃, and fourth host 305₄ executes fourth VM 235₄. It is contemplated that fault domain 310 may include any quantity of hosts 305 executing any quantity of software application instances. Further, VMs 235 hosted by hosts 305 may execute other software application instances, such as instances of network services (e.g., web applications and/or web services), distributed computing software, and/or any other type of software that is executable by computing devices such as hosts 305.

Hosts 305 communicate with each other via a network 315. Cluster system 300 also includes a monitoring device 320, which is coupled in communication with hosts 305 via network 315. In exemplary embodiments, monitoring device 320 monitors and, optionally, controls hosts 305. For example, monitoring device 320 may be configured to monitor the operation of hosts 305, such as by monitoring performance metrics associated with hosts 305, and may further coordinate the execution of VMs and/or other software applications by hosts 305 based on the performance metrics.

One or more client devices 325 are coupled in communication with network 315, such that client devices 325 may submit requests to monitoring device 320 and/or hosts 305. For example, hosts 305 may execute instances of software applications that provide data in response to requests from client devices 325. As another example, monitoring device 320 may provide performance metrics (e.g., in the form of a performance chart) to a client device 325 for presentation to a user.

Although monitoring device 320 is shown outside fault domain 310, the functions of monitoring device 320 may be incorporated into fault domain 310. For example, monitoring device 320 may be included in fault domain 310. Alternatively, the functions described with reference to monitoring device 320 may be performed by one or more hosts 305 or VMs 235 executed by one or more hosts 305 in fault domain 310. Hosts 305, monitoring device 320, and/or client device 325 may be computing devices 100 (shown in FIG. 1).

In exemplary embodiments, each host 305 in fault domain 310 provides host information to monitoring device 320. The host information includes, for example, host performance metrics associated with host 305. Monitoring device 320 receives the host information from hosts 305 in fault domain 310 and creates a visualization of host performance metrics, as described in more detail below.

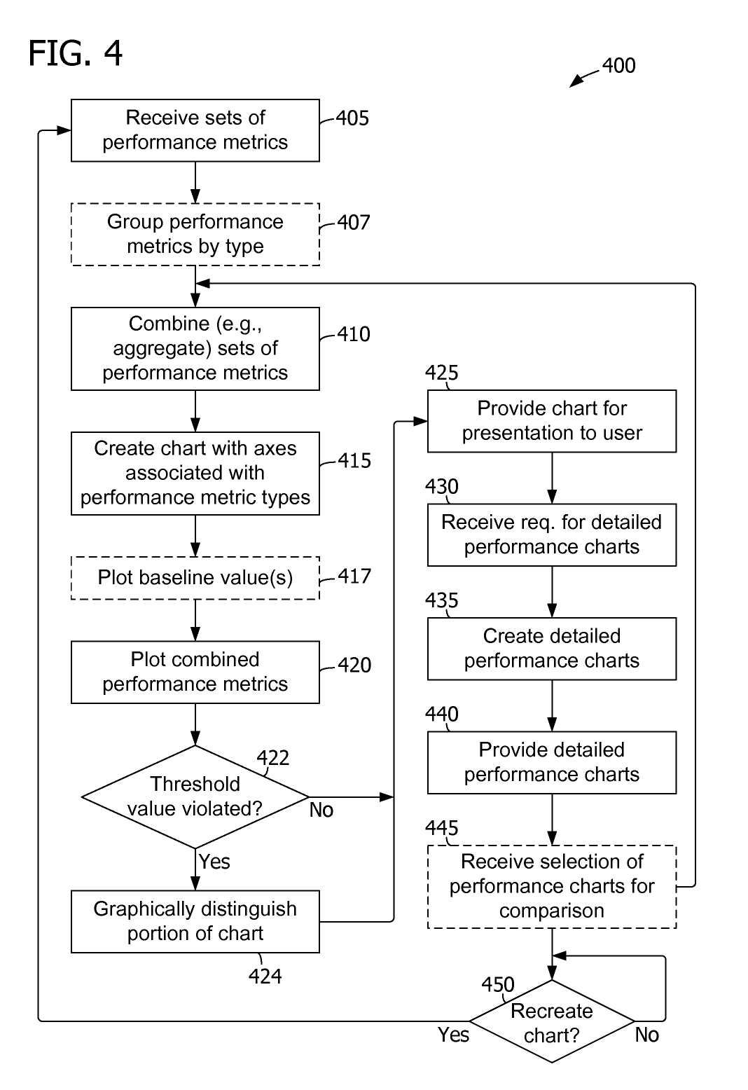

FIG. 4 is a flowchart of an exemplary method 400 performed by a monitoring device, such as monitoring device 320. Although the operations in method 400 are described with reference to monitoring device 320, it is contemplated that any portion of such operations may be performed by any computing device 100 (shown in FIG. 1).

Referring to FIGS. 3 and 4, in exemplary embodiments, monitoring device 320 receives 405 (e.g., via network communication interface 112, shown in FIG. 1) a plurality of sets of performance metrics, such as host performance metrics and/or software application (e.g., VM) performance metrics. Performance metrics may be received 405, for example, directly from hosts 305 and/or from a performance metric service (not shown). Each set of performance metrics corresponds to a software application (e.g., a VM 235) and/or a host 305 executing one or more software applications. Performance metrics may represent the operation, performance, and/or work load of a software application or a host 305. In exemplary embodiments, performance metrics represent the utilization of one or more computing resources by a VM 235 and/or a host 305, and/or a measure of latency associated with one or more computing resources used by a VM 235 and/or a host 305. Computing resources may include, for example, a processor, memory, network, and/or storage (e.g., a datastore). A plurality of performance metric types may be monitored, and each performance metric is associated with a performance metric type that indicates the computing resource and the characteristic (e.g., utilization and/or latency) represented by the performance metric.

In exemplary embodiments, performance metrics are expressed numerically. For example, processor utilization may be expressed as a percentage of processor capacity used by a software application instance (e.g., a VM 235) executed by a host 305, and network utilization may be expressed as the quantity of data being transmitted and/or received by a host 305 and/or VM 235 via a network (e.g., network 315). Further, performance metrics may be expressed as absolute values (e.g., processor megahertz used by executing processes) and/or as relative values (e.g., a proportion of available processor megahertz used by executing processes). A performance metric may be an instantaneous value, such as a single reading provided by resource monitoring software (e.g., an operating system and/or application software) executed by a host 305. Alternatively, a performance metric may be calculated as a moving average of such readings provided over a predetermined period of time (e.g., one second, five seconds, or thirty seconds).

Monitoring device 320 combines 410 the sets of performance metrics to create combined performance metrics. In some embodiments, the performance metrics are combined 410 by including the performance metrics from each set of performance metrics in a set of combined performance metrics.

In other embodiments, the performance metrics are combined 410 by grouping 407 the performance metrics from the received sets of performance metrics by performance metric type and combining the performance metrics associated with each performance metric type to create a set of aggregate performance metrics. Each aggregate performance metric is associated with a performance metric type. In such embodiments, the performance metrics associated with a first performance metric type may be combined, for example, by summing or averaging the performance metrics associated with the first performance metric type to create an aggregate performance metric associated with the first performance metric type. Such aggregation may be performed for each performance metric type.

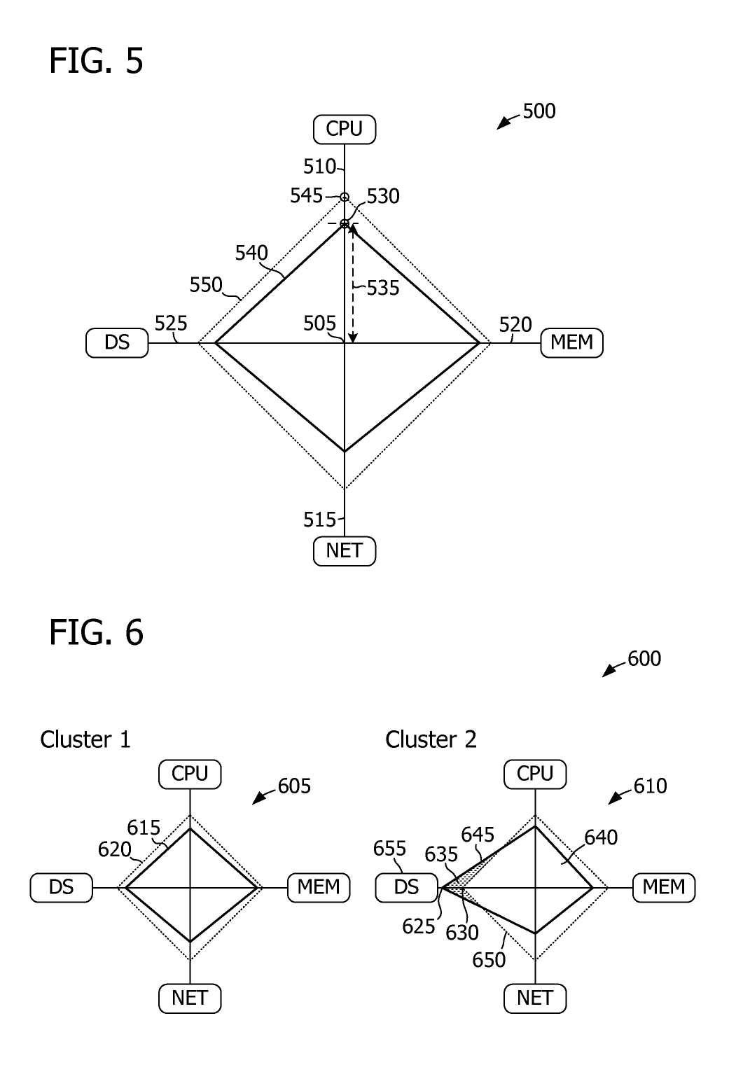

Monitoring device creates 415 a performance chart that includes a plurality of axes, each of which is associated a performance metric type of the plurality of performance metric types. FIG. 5 is an exemplary performance chart 500 that may be created 415 by monitoring device 320. Chart 500 includes, extending from an origin 505, a CPU axis 510 associated with processor utilization, a network axis 515 associated with network utilization, a memory axis 520 associated with memory utilization, and a datastore axis 525 associated with datastore utilization (e.g., a volume of datastore access). Although chart 500 is shown with four axes, it is contemplated that any quantity of axes, each associated with a performance metric type, may be included in such a performance chart.

Referring to FIGS. 4 and 5, monitoring device plots 420 each combined performance metric of the combined performance metrics on the axis that is associated with the performance metric type associated with the combined performance metric. For example, if a first performance metric is associated with processor utilization, the first performance metric is plotted 420 as a performance metric point 530 on CPU axis 510, which is also associated with the performance metric type of processor utilization. The position of performance metric point 530 (e.g., the distance 535 between performance metric point 530 and origin 505) indicates the magnitude of the first performance metric. In exemplary embodiments, such plotting 420 is performed for each combined performance metric, such that a performance metric point corresponding to a combined performance metric is plotted 420 on each axis of chart 500. Further, chart 500 may include a performance metric line 540 that connects adjacent performance metric points.

In some embodiments, monitoring device 320 plots 417 one or more baseline values associated with a performance metric type on one or more axes of chart 500. For example, if a first baseline value is associated with a first performance metric type (e.g., processor utilization), the first baseline value is plotted 417 as a baseline value point 545 at a position on the axis associated with the first performance metric type (e.g., CPU axis 510) that indicates the magnitude of the first baseline value, as described above with reference to performance metric point 530. In exemplary embodiments, the first baseline value represents a target performance metric associated with the first performance metric type, an expected performance metric associated with the first performance metric type, a previously received performance metric associated with the first performance metric type, and/or a moving average of performance metrics associated with the first performance metric type. In addition, performance chart 500 may include a baseline value line 550 that connects adjacent baseline value points.

Such embodiments facilitate comparing multiple observed values (e.g., combined performance metrics of different types) to corresponding baseline values, such that the state of cluster system 300 may be efficiently evaluated by a user. Further, in some embodiments, baseline values may be adjusted through interaction with performance chart 500. For example, monitoring device 320 may allow a user to adjust the position of baseline value point 545 on CPU axis 510 and, in response, update the baseline value represented by baseline value point 545 (e.g., within memory 104, shown in FIG. 1). Accordingly, monitoring device 320 may plot 417 baseline value point 545 based on the updated baseline value in a subsequent iteration of method 400.

Monitoring device 320 provides 425 performance chart 500 for presentation to a user. For example, referring also to FIG. 1, monitoring device 320 may directly present performance chart 500 (e.g., via presentation device 106) and/or may transmit (e.g., via network communication interface 112) performance chart 500 to a client device 325.

In some embodiments, monitoring device 320 determines 422 whether one or more threshold values is violated and, if so, graphically distinguishes 424 at least a portion of performance chart 500. Threshold values are associated with performance metric types and may include, for example, baseline values that are plotted 417 in performance chart 500 and/or other threshold values that are not plotted. A threshold value may be expressed as a minimum value or a maximum value. A maximum threshold value is considered violated when a performance metric has a value greater than the maximum threshold value. A minimum threshold value is considered violated when a performance metric has a value less than the minimum threshold value.

Further, in some embodiments, a threshold value representing a maximum deviation is associated with a baseline value, and a threshold violation is considered to occur when the difference between the baseline value and an associated performance metric exceeds the maximum deviation threshold value. For example, processor utilization may be associated with a baseline value of 70%, and this baseline value may be associated with a maximum deviation of 20%. Accordingly, monitoring device 320 may compare a performance metric associated with processor utilization to a minimum threshold value of 50% (70% minus 20%) and/or to a maximum threshold value of 90% (70% plus 20%).

Graphical distinction 424 may be accomplished using a background pattern, a background color, a line weight, a line color, an icon, an animation, and/or any other method of visually differentiating user interface elements from one another. FIG. 6 is an exemplary user interface 600 including a first performance chart 605 representing operation of a first cluster system and a second performance chart 610 representing operation of a second cluster system. First performance chart 605 represents aggregate performance metrics that do not violate any threshold values (e.g., baseline values). For example, a performance metric line 615 connecting performance metric points is entirely contained within a baseline value line 620 connecting baseline value points.

Second performance chart 610, in contrast, represents a violation of a baseline value. Specifically, a performance metric point 625 is positioned outside a baseline value point 630. Accordingly, a portion 635 of the area 640 defined by a performance metric line 645 extends outside a baseline value line 650. In exemplary embodiments, at least a portion (e.g., portion 635) is graphically distinguished 424 from first performance chart 605, in which no threshold values are violated, and/or from portions of second performance chart 610 that do not represent a violation of a threshold value. For example, portion 635 may be presented with a background pattern that is different from the background pattern of the remainder of area 640. In some embodiments, portions of area 640 within baseline value line 650 are presented in one color (e.g., green), and portions of area 640 outside baseline value line 650 (e.g., portion 635) are presented in another color (e.g., red). In addition, portions of area 640 within, but near (e.g., within 5% of) baseline value line 650 may be presented in a third color (e.g., yellow). In addition, or alternatively, monitoring device 320 may apply such graphical distinction to a portion of performance metric line 645 (e.g., the portion outside baseline value line 650), to a label 655 associated with the performance metric type that is associated with the violated threshold value, and/or to the entirety of area 640. Such embodiments facilitate conveying potentially concerning performance metrics using easily detected visual cues, such as color.

In some embodiments, monitoring device 320 graphically distinguishes 424 a portion of a performance chart when a performance metric that is not associated with an axis in the performance chart violates a predetermined threshold value. For example, each performance metric that is associated with an axis in the chart may be a utilization metric that represents a utilization of a particular computing resource. Monitoring device 320 may also receive 405 and/or combine 410 latency metrics (e.g., network latency and/or datastore latency), each of which represents a latency associated with a computing resource. Accordingly, one or more of the computing resources whose utilization is represented by a utilization metric may also be associated with a latency metric and with a latency threshold value. Monitoring device 320 may graphically distinguish 424 at least a portion of the performance chart when a latency metric violates a predetermined threshold value.

Some embodiments enable a user to view performance charts representing individual hosts 305 and/or VMs 235 that are included in the group of hosts (e.g., a cluster system) corresponding to a performance chart that represents a combined performance metrics. In such embodiments, monitoring device 320 receives 430 a request for detailed (e.g., host and/or VM) performance charts from a user. For example, the user may request host performance charts by selecting at least a portion of an aggregate performance chart that represents aggregate performance metrics corresponding to a plurality of hosts 305. Similarly, the user may request VM performance charts by selecting at least a portion of an aggregate performance chart that represents aggregate performance metrics corresponding to a plurality of VMs 235.

In response to the received request, monitoring device creates 435 a plurality of detailed performance charts and provides 440 the detailed performance charts for presentation to a user. Each detailed performance chart represents a set of performance metrics that was represented in the aggregate performance chart provided 425 by monitoring device 320.

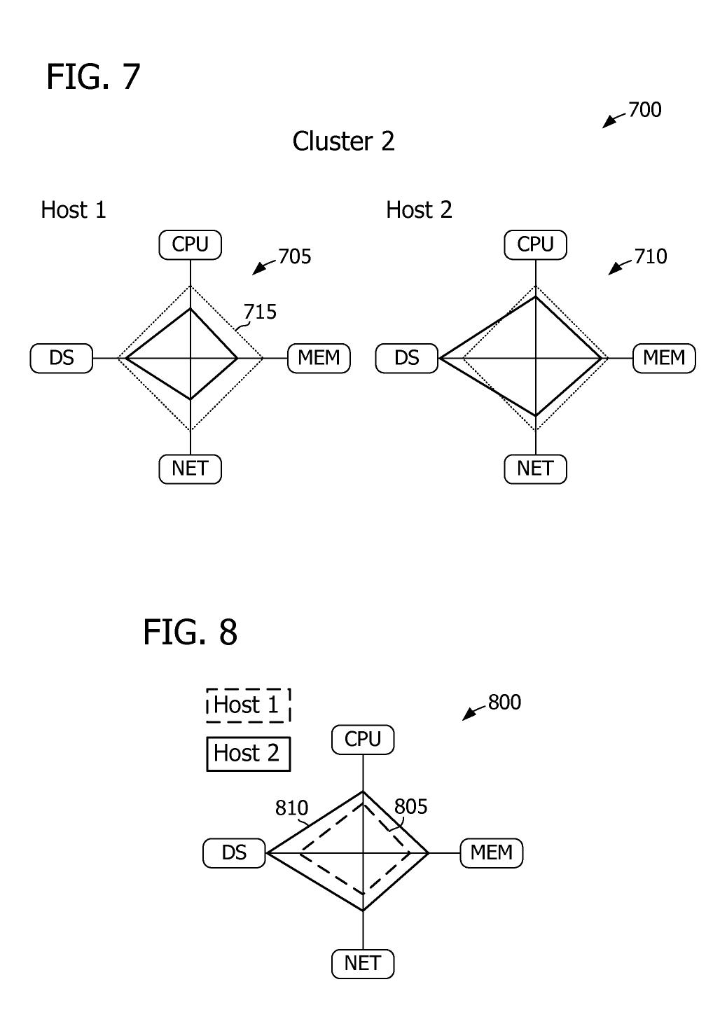

FIG. 7 is an exemplary user interface 700 including a first host performance chart 705 and a second host performance chart 710. In exemplary embodiments, first host performance chart 705 is created 435 in a manner similar to that described above with reference to performance chart 500 (shown in FIG. 5), but using the set of performance metrics associated with a first host instead of the combined performance metrics. Similarly, second host performance chart 710 is created 435 based on the set of performance metrics associated with a second host. Although two host performance charts are shown, it is contemplated that monitoring device may create 435 and provide 440 host performance charts representing the operation of all hosts within a group (e.g., a cluster system). In some embodiments, a host performance chart, such as first host performance chart 705, includes a baseline value line 715. The baseline value line 715 may be plotted in a manner similar to that described above with reference to baseline value line 550 (shown in FIG. 5). Alternatively, baseline value line 715 may represent aggregate performance metrics associated with the group (e.g., cluster system) of computing devices that includes the first host and the second host. For example, baseline value line 715 may be plotted as described above with reference to performance metric line 540 (shown in FIG. 5), enabling a comparison of host performance metrics to the aggregate (e.g., averaged) performance metrics within the group.

Providing 440 host performance charts upon request, as described above, facilitates providing detailed information regarding individual hosts when desired by a user (e.g., when a threshold value is violated) while maintaining a relatively simple user interface with a reduced set of charts when such detailed information is not desired.

In some embodiments, receiving 405 performance metrics includes receiving VM performance metrics, which may be associated with the same performance metric types as described above with reference to host performance metrics. In such embodiments, monitoring device 320 may provide 440 host performance charts as detailed performance charts corresponding to an aggregate performance chart, and may similarly provide 440 VM performance charts as detailed performance charts corresponding to a host performance chart.

In some embodiments, performance charts may combined, such as by overlaying performance charts representing combined performance metrics and/or host performance metrics. FIG. 8 is an exemplary combined performance chart 800 that may be created by combining first host performance chart 705 and second host performance chart 710 (shown in FIG. 7). In exemplary embodiments, monitoring device 320 receives 445 a selection of a plurality of host performance charts, such as first host performance chart 705 and second host performance chart 710. In response, monitoring device 320 combines 410 the host performance metrics associated with the first host and the second host and creates 415 combined performance chart 800, such as by plotting 420 the performance metrics associated with the first host to create a first performance metric line 805, and plotting 420 the performance metrics associated with the second host to create a second performance metric line 810. First performance metric line 805 may be graphically distinguished from second performance metric line 810, such as by applying different line patterns and/or colors to first performance metric line 805 and second performance metric line 810. Such embodiments facilitate comparing performance metrics associated with a plurality of hosts and/or a plurality of cluster systems.

Referring to FIGS. 3 and 4, method 400 may be performed repeatedly (e.g., continuously, periodically, or upon request). In exemplar embodiments, monitoring device 320 determines 450 whether to recreate the performance chart provided 425 for presentation to the user. For example, monitoring device 320 may determine 450 that the performance chart should be recreated based on receiving an update or “refresh” request from a user and/or upon a predetermined period of time (e.g., thirty seconds, one minute, or five minutes) elapsing. When monitoring device 320 determines 450 that the performance chart should be recreated, monitoring device 320 may again perform at least a portion of method 400. Accordingly, performance charts provided 425 by monitoring device 320 may be automatically updated to reflect changes in performance metrics over time.

The methods described may be performed by computing devices, such as monitoring system 320, client devices 325, and/or hosts 305 in cluster system 300 (shown in FIG. 3). The computing devices communicate with each other through an exchange of messages and/or stored data. A computing device may transmit a message as a broadcast message (e.g., to an entire network and/or data bus), a multicast message (e.g., addressed to a plurality of other computing devices), and/or as a plurality of unicast messages, each of which is addressed to an individual computing device. Further, in some embodiments, messages are transmitted using a network protocol that does not guarantee delivery, such as User Datagram Protocol (UDP). Accordingly, when transmitting a message, a computing device may transmit multiple copies of the message, enabling the computing device to reduce the risk of non-delivery.

### Exemplary Operating Environment

The operations described herein may be performed by a computer or computing device. A computer or computing device may include one or more processors or processing units, system memory, and some form of computer readable media. Exemplary computer readable media include flash memory drives, digital versatile discs (DVDs), compact discs (CDs), floppy disks, and tape cassettes. By way of example and not limitation, computer readable media comprise computer-readable storage media and communication media. Computer-readable storage media store information such as computer readable instructions, data structures, program modules, or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the disclosure are operative with numerous other general purpose or special purpose computing system environments or configurations. Examples of well known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other embodiments of the disclosure may include different computer-executable instructions or components having more or less functionality than illustrated and described herein.

Aspects of the disclosure transform a general-purpose computer into a special-purpose computing device when programmed to execute the instructions described herein.

The operations illustrated and described herein may be implemented as software instructions encoded on a computer-readable medium, in hardware programmed or designed to perform the operations, or both. For example, aspects of the disclosure may be implemented as a system on a chip.

The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for monitoring operation of a plurality of hosts executing a plurality of virtual machines (VMs), the system comprising:
a network communication interface configured to receive a plurality of sets of host performance metrics, wherein each set of host performance metrics corresponds to a host executing one or more VMs, and each host performance metric is associated with a performance metric type of a plurality of performance metric types; and
a processor coupled to the network communication interface and programmed to:
combine the sets of host performance metrics to create combined performance metrics;
create a chart including a plurality of axes, wherein each axis of the plurality of axes is associated a performance metric type of the plurality of performance metric types; and
plot each combined performance metric of the combined performance metrics on the axis that is associated with the performance metric type associated with the combined performance metric.

2. The system of claim 1, wherein the processor is programmed to combine the sets of host performance metrics by combining, from the plurality of sets of host performance metrics, the host performance metrics associated with each performance metric type to create a set of aggregate performance metrics, wherein each aggregate performance metric is associated with a performance metric type.

3. The system of claim 2, wherein the processor is programmed to combine the host performance metrics associated with a first performance metric type of the performance metric types by summing the host performance metrics associated with the first performance metric type.

4. The system of claim 2, wherein the processor is programmed to combine the host performance metrics associated with a first performance metric type of the performance metric types by averaging the host performance metrics associated with the first performance metric type.

5. The system of claim 2, wherein the processor is further programmed to:
in response to a request for detailed performance charts, create a plurality of VM performance charts, wherein each VM performance chart represents a set of VM performance metrics corresponding to VM executed by a first host of the plurality of hosts; and
provide the VM performance charts for presentation to a user.

6. The system of claim 1, wherein the processor is programmed to combine the sets of performance metrics by including the performance metrics from each set of performance metrics in the combined performance metrics.

7. The system of claim 1, wherein the processor is further programmed to plot a baseline value on a first axis of the plurality of axes, wherein the first axis is associated with a first performance metric type, and the baseline value represents one or more of the following: a target performance metric associated with the first performance metric type, a previously received performance metric associated with the first performance metric type, and a moving average of performance metrics associated with the first performance metric type.

8. A method comprising:
combining, by a computing device, a plurality of sets of host performance metrics to create a set of aggregate performance metrics, wherein each set of host performance metrics corresponds to a host computing device of a plurality of host computing devices, and each host performance metric and aggregate performance metric is associated with a performance metric type of a plurality of performance metric types;
creating, by the computing device, an aggregate performance chart including a plurality of axes, wherein each axis of the plurality of axes is associated a performance metric type of the plurality of performance metric types;
plotting, by the computing device, each aggregate performance metric of the set of aggregate performance metrics on the axis that is associated with the performance metric type associated with the aggregate performance metric; and
providing, by the computing device, the aggregate performance chart for presentation to a user.

9. The method of claim 8, further comprising:
receiving, by the computing device, a request for host performance charts from the user;
in response to the received request, creating, by the computing device, a plurality of host performance charts, wherein each host performance chart represents the set of host performance metrics corresponding to a host computing device of the plurality of host computing devices; and
providing, by the computing device, the host performance charts for presentation to a user.

10. The method of claim 9, wherein each host performance chart includes a plurality of axes, each axis of the plurality of axes associated with a performance metric type of the plurality of performance metric types, the method further comprising, for each host performance chart, plotting, by the computing device, each host performance metric of the associated set of host performance metrics on the axis that is associated with the performance metric type associated with the host performance metric.

11. The method of claim 9, further comprising:
receiving a selection of a first host performance chart and a second host performance chart of the plurality of host performance charts; and
combining the first host performance chart and the second host performance chart to create a combined host performance chart.

12. The method of claim 8, wherein plotting each aggregate performance metric of the set of aggregate performance metrics comprises plotting one or more of the following: an aggregate processor utilization, an aggregate memory utilization, an aggregate network utilization, and an aggregate volume of storage access.

13. The method of claim 8, further comprising graphically distinguishing at least a portion of the aggregate performance chart when an aggregate performance metric that is not associated with an axis in the aggregate performance chart violates a predetermined threshold value.

14. One or more computer-readable storage media embodying computer-executable components, said components comprising:
a combination component that when executed causes at least one processor to combine a plurality of sets of host performance metrics to create combined performance metrics, wherein each set of host performance metrics corresponds to a host computing device, and each host performance metric is associated with a performance metric type of a plurality of performance metric types; and
a charting component that when executed causes at least one processor to:
create a chart including a plurality of axes, wherein each axis of the plurality of axes is associated a performance metric type of the plurality of performance metric types;
plot each combined performance metric of the combined performance metrics on the axis that is associated with the performance metric type associated with the combined performance metric; and
plot a baseline value on a first axis of the plurality of axes, wherein the first axis is associated with a first performance metric type of the plurality of performance metric types, and the baseline value represents one or more of the following: a target performance metric associated with the first performance metric type, a previously received host performance metric associated with the first performance metric type, a previously created combined performance metric associated with the first performance metric type, and a moving average of host performance metrics associated with the first performance metric type.

15. The computer-readable storage media of claim 14, wherein the charting component further causes the at least one processor to graphically distinguish at least a portion of the chart when a difference between the baseline value and a combined performance metric associated with the first performance metric type exceeds a predetermined threshold value.

16. The computer-readable storage media of claim 14, wherein the charting component further causes the at least one processor to graphically distinguish at least a portion of the chart when a combined performance metric that is not associated with an axis in the chart violates a predetermined threshold value.

17. The computer-readable storage media of claim 16, wherein each combined performance metric that is associated with an axis in the chart represents a utilization of a computing resource, and the charting component further causes the at least one processor to graphically distinguish at least a portion of the chart when a combined performance metric representing a latency associated with a computing resource violates a predetermined threshold value.

18. The computer-readable storage media of claim 14, wherein the charting component causes the at least one processor to plot a baseline value on each axis of the plurality of axes.

19. The computer-readable storage media of claim 14, wherein the combination component causes the at least one processor to combine the sets of host performance metrics by combining, from the plurality of sets of host performance metrics, the host performance metrics associated with each performance metric type to create a set of aggregate performance metrics, wherein each aggregate performance metric is associated with a performance metric type.

20. The computer-readable storage media of claim 14, wherein the combination component causes the at least one processor to combine the sets of host performance metrics by including the host performance metrics from each set of host performance metrics in the combined performance metrics.
